(19) United States
(12) Patent Application Publication
(10) Pub. No.: US 2012/0186160 A1
(43) Pub. Date: Jul. 26, 2012

(54) METHOD FOR MODIFICATION OF CEMENTED CARBIDES AND CEMENTED CARBIDES MODIFIED BY THE METHOD

(75) Inventors: Yoshiaki Morisada, Osaka (JP); Toru Nagaoka, Osaka (JP); Masao Fukusumi, Osaka (JP); Tadashi Mizuno, Osaka (JP); Genryu Abe, Osaka (JP); Hidetoshi Fujii, Osaka (JP)

(73) Assignee: Osaka University, Osaka (JP)

(21) Appl. No.: 13/389,792

(22) PCT Filed: Aug. 10, 2010
(86) PCT No.: PCT/JP2010/063584

§ 371 Date: Apr. 10, 2012

(30) Foreign Application Priority Data
Aug. 10, 2009 (JP) 2009 185651

(51) Int. Cl. C09K 3/14; B24B 1/00

(52) U.S. Cl. 51/307; 451/32

(57) ABSTRACT

Provided are a method of modifying a cemented carbide and a cemented carbide modified by the method. Particularly provided is an advantageous method of modifying a cemented carbide layer formed by a thermal spraying method on a surface of a metal substrate. The method of modifying a cemented carbide includes applying a friction stir process to a cemented carbide, thereby allowing crystal grains in a binder phase included in the cemented carbide to become finer. It is possible to achieve modification effectively by applying the friction stir process particularly to a cemented carbide layer formed on a surface of a metal substrate by using the thermal spraying method.

### TECHNICAL FIELD

The present invention relates to a method of modifying a cemented carbide and a cemented carbide modified by the method, and more particularly, to an advantageous method of modifying a cemented carbide layer formed on a surface of a metal substrate by a thermal spraying method.

### BACKGROUND ART

A cemented carbide is an alloy produced by sintering hard ceramic particles with a binder phase of an iron group metal (Fe, Ni, or Co). The cemented carbide has both excellent wear resistance and excellent fracture toughness, and hence is broadly used for various kinds of cutting tools and sliding members, and the like. However, along with rapid progress of industry in recent years, demands for mechanical properties of the cemented carbide have been increasing day by day, and hence research and development has been widely made for improving the mechanical properties of the cemented carbide.

As a binder phase decreases in the cemented carbide, its hardness, wear resistance, compressive strength, resistance to high-temperature degradation, and the like improve. Hence, a binderless cemented carbide is proposed (for example, Patent Literature 1), but the binderless cemented carbide involves problems with fracture toughness and the like as with the case of a ceramic sintered compact. Further, when cemented carbides having the same kind of binder phase are compared, a cemented carbide produced by using finer hard ceramic particles has a higher hardness. Hence, cemented carbides produced by using nanosized hard ceramic particles are proposed (Non Patent Literatures 1 and 2). However, the nanosized hard ceramic particles are bound to each other with a general binder phase of an iron group metal, and hence the proposed cemented carbides have not yet exhibited mechanical properties good enough for meeting the demands required in the fields of cutting tools, sliding members, and the like.

Moreover, the cemented carbide is mainly formed of rare elements such as tungsten, cobalt, and nickel, and hence involves problems from the viewpoints of a cost and natural resource saving as well. In addition, the cemented carbide is often produced by using pressure sintering, and consequently, the size and shape of a sintered compact produced by using the technique are restricted depending on a sintering apparatus. As a technique for overcoming these problems, various studies have been made a technology for forming a cemented carbide layer by using a thermal spraying method (Patent Literatures 2 and 3). When a cemented carbide layer is formed on the surface of a substrate, not only the usage of the cemented carbide can be reduced in comparison to its usage in the sintered compact, but also demands for various shapes and sizes can be met.

### CITATION LIST

### Patent Literature

[PTL 1] JP 2003-81649 A

[PTL 2] JP 07-11418 A

[PTL 3] JP 10-158809 A

### Non Patent Literature

[NPL 1] Nanostructured novel cemented hard alloy obtained by mechanical alloying and hot-pressing sintering and its applications, Journal of Alloys and Compounds 462 (2008) 416-420.

[NPL 2] Synthesis, sintering, and mechanical properties of nanocrystalline cemented tungsten carbide-A review, Int. Journal of Refractory Metals & Hard Materials, 27 (2009) 288-299.

### SUMMARY OF THE INVENTION

### Technical Problem

In regard to any cemented carbide having a binder phase, improvements in the mechanical properties of the cemented carbide can be expected by increasing the strength of the binder phase, but a universal, effective technique for increasing the strength of a binder phase has not been established. Moreover, a cemented carbide layer formed by using a thermal spraying method involves problems such as (1) inevitably having defects such as voids, (2) having poor adhesiveness to a substrate, and (3) having lower mechanical properties in comparison to a cemented carbide sintered compact.

The present invention has been made in view of the above-mentioned problems. The present invention provides a method of modifying a cemented carbide and a cemented carbide modified by the method, and particularly provides an advantageous modifying method beneficial to improving the densification of a cemented carbide and its mechanical properties, the method being also applicable to a cemented carbide layer formed by a thermal spraying method.

### Solution to Problem

A method of modifying a cemented carbide according to the present invention includes applying a friction stir process to a cemented carbide, thereby allowing crystal grains in a binder phase included in the cemented carbide to become finer. It is possible to achieve modification effectively by applying the friction stir process particularly to a cemented carbide layer (thermally sprayed cemented carbide layer) formed on the surface of a metal substrate by using a thermal spraying method. The metal substrate and the thermally sprayed cemented carbide layer are welded metallurgically through the friction stir process. In addition, it is possible to make the hardness of the metal substrate higher than that before the application of the friction stir process, in the vicinity of an interface between the thermally sprayed cemented carbide layer and the metal substrate.

The method of modifying a cemented carbide according to the present invention can be applied to each of cemented carbides having various binder phases, and the method is preferably used for a cemented carbide which has a nickel-based binder phase and whose mechanical properties are relatively difficult to improve. Further, various tools can be used in the friction stir process, and it is preferred to use a tool made of a cemented carbide having a higher hardness than a cemented carbide which is a material to be modified.

A cemented carbide of the present invention can be produced by the method of modifying a cemented carbide according to the present invention. That is, through the application of a friction stir process to a cemented carbide, crystal grains in its binder phase are allowed to become finer. Various tools can be used in the friction stir process, and it is preferred to use a tool made of a cemented carbide having a higher hardness than a cemented carbide which is a material to be modified.

When the material to be modified is a thermally sprayed cemented carbide layer, a metal substrate and the thermally sprayed cemented carbide layer are welded metallurgically through the friction stir process, and the hardness of the metal substrate is higher than that before the application of the friction stir process, in the vicinity of an interface between the thermally sprayed cemented carbide layer and the metal substrate. The kind of cemented carbide that can be treated is not particularly limited and cemented carbides having various binder phases may be treated, but it is preferred to use a cemented carbide which has a nickel-based binder phase and whose mechanical properties are relatively difficult to improve. Further, the binder phase preferably includes crystal grains each having an average diameter of 1 μm or less.

### ADVANTAGEOUS EFFECTS OF INVENTION

According to the method of modifying a cemented carbide according to the present invention, crystal grains in a binder phase in a cemented carbide are allowed to become finer, thereby increasing the strength of the binder phase, and consequently, the mechanical properties of the cemented carbide can be improved. Further, when the present invention is applied to a cemented carbide layer formed by using a thermal spraying method, it is possible to eliminate defects such as voids inevitably existing in the thermally sprayed cemented carbide layer and to improve the adhesiveness of the thermally sprayed cemented carbide layer to a substrate through metallurgical welding.

In the cemented carbide of the present invention, the binder phase has increased strength because crystal grains in the binder phase have been allowed to become finer, and hence the cemented carbide has excellent mechanical properties in comparison to similar types of cemented carbides in which crystal grains have not been allowed to become finer. Further, the cemented carbide is a thermally sprayed cemented carbide layer, defects such as voids inevitably existing in the thermally sprayed cemented carbide layer are significantly reduced, and moreover, the adhesiveness between the thermally sprayed cemented carbide layer and a substrate is improved through metallurgical welding. The cemented carbide of the present invention can be widely used for applications requiring high hardness, high toughness, high wear resistant property, and the like, and can be used for, for example, T-dies for forming various kinds of film sheets.

### BRIEF DESCRIPTION OF DRAWINGS

FIG. 1 is a schematic diagram of a method of modifying a cemented carbide according to the present invention.

FIG. 2 is a cross-sectional schematic diagram of a cemented carbide modified by applying the method of modifying a cemented carbide according to the present invention.

FIG. 3 is a schematic diagram illustrating a case of applying the method of modifying a cemented carbide according to the present invention to a thermally sprayed cemented carbide layer.

FIG. 4 is a cross-sectional schematic diagram of a thermally sprayed cemented carbide layer modified by applying the method of modifying a cemented carbide according to the present invention.

FIG. 5 is an SEM photograph of a cross-section of a sample obtained in Example 1 of the present invention.

FIG. 6 is an SEM photograph of a thermally sprayed cemented carbide layer in the sample obtained in Example 1.

FIG. 7 is a TEM photograph (low magnification) of the thermally sprayed cemented carbide layer in the sample obtained in Example 1.

FIG. 8 is a TEM photograph (high magnification) of the thermally sprayed cemented carbide layer in the sample obtained in Example 1.

FIG. 9 shows an SEM photograph and EDS element mapping results of an interface between the thermally sprayed cemented carbide layer and an SKD61 sheet material in the sample obtained in Example 1.

FIG. 10 is an SEM photograph of a thermally sprayed cemented carbide layer in a sample obtained in Example 2.

FIG. 11 is a TEM photograph (low magnification) of the thermally sprayed cemented carbide layer in the sample obtained in Example 2.

FIG. 12 is a TEM photograph (high magnification) of the thermally sprayed cemented carbide layer in the sample obtained in Example 2.

FIG. 13 is a graph plotting the Vickers hardness of the thermally sprayed cemented carbide layer measured before and after a friction stir process.

FIG. 14 shows an SEM photograph and EDS element mapping results of an interface between the thermally sprayed cemented carbide layer and an SKD61 sheet material in the sample obtained in Example 2.

### DESCRIPTION OF EMBODIMENTS

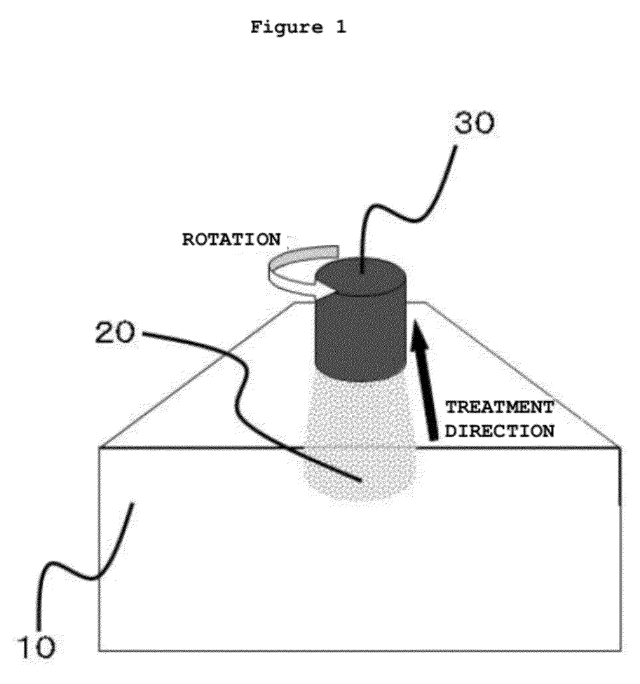

FIG. 1 illustrates a schematic diagram of a method of modifying a cemented carbide according to the present invention. A tool for a friction stir process 30 having a cylindrical shape and rotating at a high speed is pressed into a cemented carbide 10 and the tool for a friction stir process 30 is moved in any direction, thereby modifying the cemented carbide 10. Note that, when the tool for a friction stir process 30 is drawn out without being moved after the pressing thereof into the cemented carbide, there is provided a modified region corresponding to the bottom shape of the tool for a friction stir process 30. A plastic flow occurs in a region which is stirred with the tool for a friction stir process 30, and consequently, defects such as voids existing in the cemented carbide 10 are eliminated and crystal grains in its binder phase are allowed to become finer.

The friction stir process was established by applying a friction stir welding method as a method of modifying the surface of a metal material, the friction stir welding method being a welding technology devised by The Welding Institute (TWI) in Britain in 1991. Friction stir welding is a technology for attaining welding by pressing a cylindrical tool rotating at a high speed into a region to be welded (the tool has projections called probes on its bottom surface and the probes are pressed into) to soften a material to be welded with friction heat, and scanning the softened material in a direction in which the welding is intended while stirring the material. The region stirred with the rotating tool is generally called a stirred portion, and, depending on welding conditions, the stirred portion is improved in mechanical properties owing to the homogenization of a material and the reduction of the diameters of crystal grains. It is the friction stir process that is a technology for using, as surface modification, the improvement of the mechanical properties owing to the homogenization of a material and the reduction of the diameters of crystal grains caused by friction stir, and the friction stir process has been widely studied in recent years. Note that the tool for a friction stir process 30 used in the present invention is not necessarily provided with probes on its bottom surface, and it is possible to use a so-called flat tool having no probes.

It is possible to use, for the cemented carbide 10, a cemented carbide having any of various kinds of binder phases and any of various kinds of hard ceramic particles. The binder phases can be exemplified by phases of iron group metals (Fe, Ni, and Co) and of solid solutions thereof. The hard ceramic particles can be exemplified by particles of carbides such as WC, TiC, VC, Mo₂C, ZrC, HfC, NbC, TaC, Cr₃C₂, and SiC, of nitrides such as Si₃N₄, of borides such as TiB₂, and of oxides such as Al₂O_{3.}

It is possible to use, for the tool for a friction stir process 30, a tool having better mechanical properties (such as hardness, thermal shock resistance, and deformation resistance at a temperature at which a friction stir process is performed) than the cemented carbide 10. In consideration of a case where a fragment of the tool for a friction stir process 30 is mixed in the cemented carbide 10 at the time of a friction stir process, the tool for a friction stir process 30 is preferably made of a cemented carbide. The tool for a friction stir process 30 made of a cemented carbide to be used needs to have better mechanical properties than the cemented carbide 10, and for example, a tool having a higher hardness than the cemented carbide 10 needs to be selected.

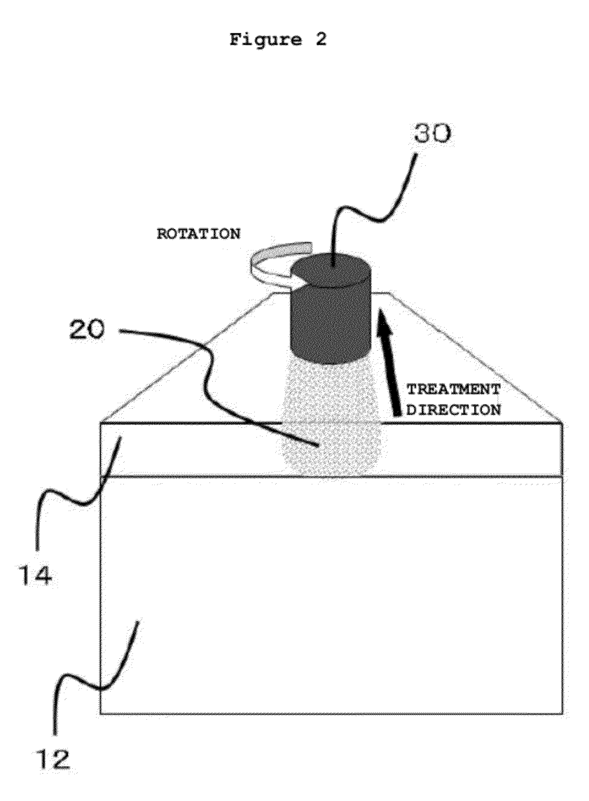

FIG. 2 illustrates a cross-sectional schematic diagram of a cemented carbide modified by applying the method of modifying a cemented carbide according to the present invention. In the vicinity of a surface of the cemented carbide 10, there exists a modified region 20 formed by pressing the tool for a friction stir process 30 thereinto. The crystal grains in the binder phase included in the modified region 20 have been allowed to become finer and preferably have an average diameter of 1 μm or less.

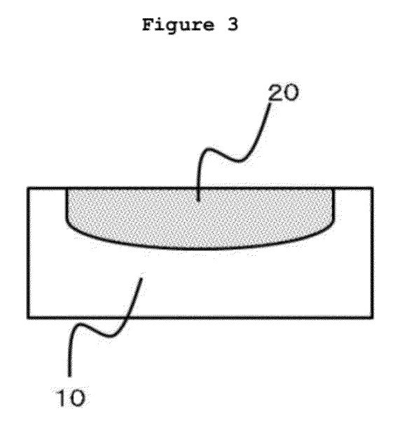

FIG. 3 is a schematic diagram illustrating a case of applying the method of modifying a cemented carbide according to the present invention to a thermally sprayed cemented carbide layer. The tool for a friction stir process 30 having a cylindrical shape and rotating at a high speed is pressed into a thermally sprayed cemented carbide layer 14 and the tool for a friction stir process 30 is moved in any direction, thereby modifying the thermally sprayed cemented carbide layer 14. Note that, when the tool for a friction stir process 30 drawn out without being moved after the pressing thereof into the layer, there is provided a modified region corresponding to the bottom shape of the tool for a friction stir process 30. A plastic flow occurs in a region which is stirred with the tool for a friction stir process 30, and consequently, defects such as voids existing in the thermally sprayed cemented carbide layer 14 are eliminated and the crystal grains in its binder phase allowed to become finer. Further, the plastic flow occurring at the time of the friction stir process and heat input metallurgically weld the thermally sprayed cemented carbide layer 14 and a metal substrate 12. In addition, the hardness of the metal substrate 12 becomes higher than that before the friction stir process, in the vicinity of the welded interface between the modified thermally sprayed cemented carbide layer 14 and the metal substrate 12.

It is possible to use, for the tool for a friction stir process 30, a tool having better mechanical properties (such as hardness, thermal shock resistance, and deformation resistance at a temperature at which a friction stir process is performed) than the thermally sprayed cemented carbide layer 14. In consideration of a case where a fragment of the tool for a friction stir process 30 is mixed in the thermally sprayed cemented carbide layer 14 at the time of a friction stir process, the tool for a friction stir process 30 is preferably made of a cemented carbide. The tool for a friction stir process 30 made of a cemented carbide to be used needs to have better mechanical properties than the thermally sprayed cemented carbide layer 14, and for example, a tool having a higher hardness than the thermally sprayed cemented carbide layer 14 needs to be selected. Specifically, when the thermally sprayed cemented carbide layer 14 is a WC-CrC-Ni layer, a WC-Co material or the like can be used for the tool for a friction stir process 20.

A method of forming the thermally sprayed cemented carbide layer 14 is not particularly limited, and various kinds of thermal spraying methods each using gas combustion energy or electric energy (plasma, ark, or the like) can be used. Specifically, it is possible to use gas flame spraying, high velocity oxy-fuel (HVOF), arc spraying, plasma spraying, vacuum plasma spraying (VPS), or the like.

The friction stir process is a process in which the tool for a friction stir process 30 rotating at a high speed is pressed into a material to be treated, causing a plastic flow, and hence the friction stir process is difficult to be applied to a material to be treated having high plastic deformation resistance. A cemented carbide is a typical material having high plastic deformation resistance, and hence the friction stir process is, in general, difficult to be applied to it. Here, the thermally sprayed cemented carbide layer 14 is thin and has poor adhesiveness to the metal substrate 12, and hence a plastic flow is easily caused to occur therein and the friction stir process can be easily applied thereto in comparison to a cemented carbide sintered compact.

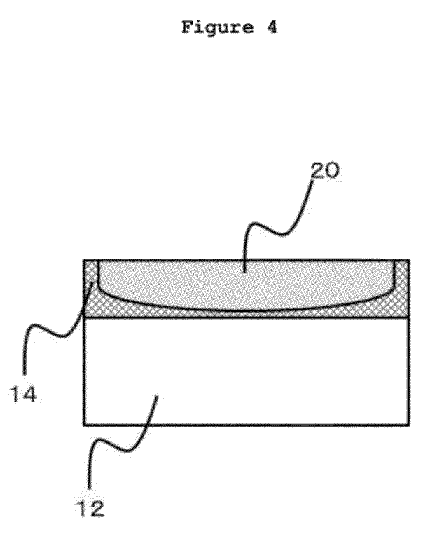

FIG. 4 illustrates a cross-sectional schematic diagram of a thermally sprayed cemented carbide layer modified by applying the method of modifying a cemented carbide according to the present invention. The thermally sprayed cemented carbide layer 14 includes the modified region 20 formed by pressing the tool for a friction stir process 30 thereinto. The modified region 20 may be present in the state of spreading even in the metal substrate 12 depending on the thickness of the thermally sprayed cemented carbide layer 14 and the conditions of the friction stir process. The crystal grains in the binder phase included in the modified region 20 have been allowed to become finer and preferably have an average diameter of 1 pm or less. Further, defects such as voids existing in the thermally sprayed cemented carbide layer 14 are eliminated by the friction stir process, and hence defects included in the modified region 20 are significantly reduced. In addition, the thermally sprayed cemented carbide layer 14 and the metal substrate 12 are metallurgically welded, and the hardness of the metal substrate 12 is higher than that before the friction stir process, in the vicinity of the welded interface between the modified thermally sprayed cemented carbide layer 14 and the metal substrate 12.

### EXAMPLES

Hereinafter, examples and comparative examples of the present invention are described with reference to the drawings, but the present invention is not limited to these examples.

### Example 1 (Formation of Thermally Sprayed Cemented Carbide Layer)

A high velocity flame spraying method was used to form a thermally sprayed cemented carbide layer on an SKD61 sheet material. Used as raw material powder were Ni particles including 20 mass % of WC and 7 mass % of CrC and each having an average diameter of 40 μm produced by using a gas atomization method.

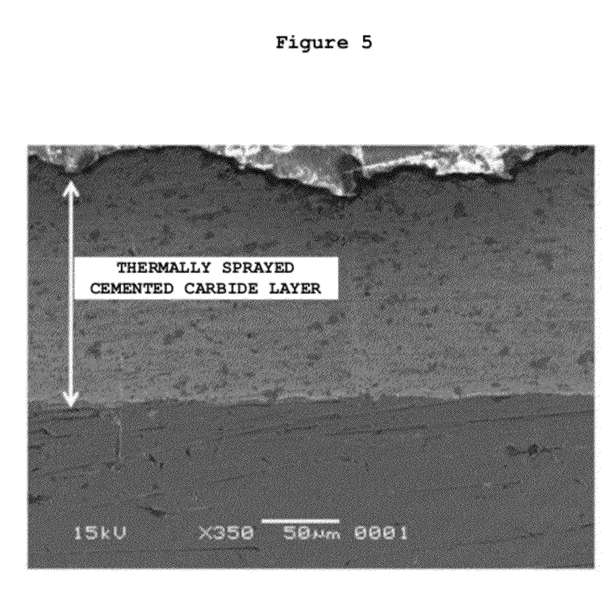

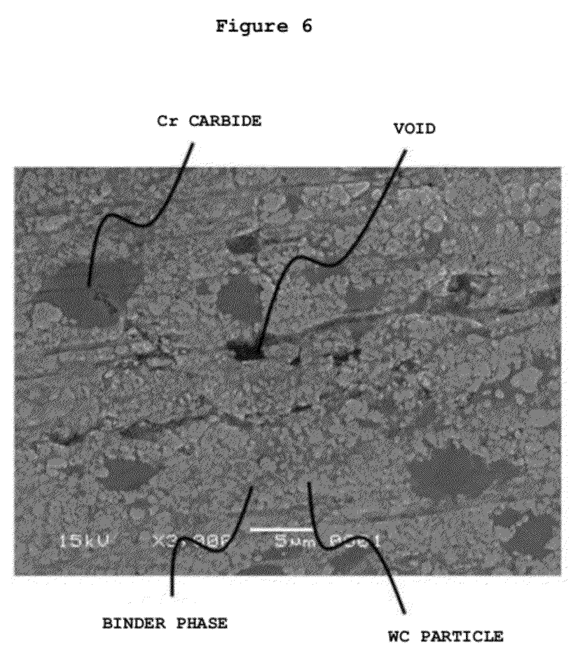

FIG. 5 shows an SEM photograph of a cross-section of the resultant sample and FIG. 6 shows an SEM photograph of the thermally sprayed cemented carbide layer in the sample. A thermally sprayed cemented carbide layer having a thickness of about 300 μm is formed on the surface of the SKD61 sheet material. Further, it can be confirmed that many defects such as voids are present in the thermally sprayed cemented carbide layer.

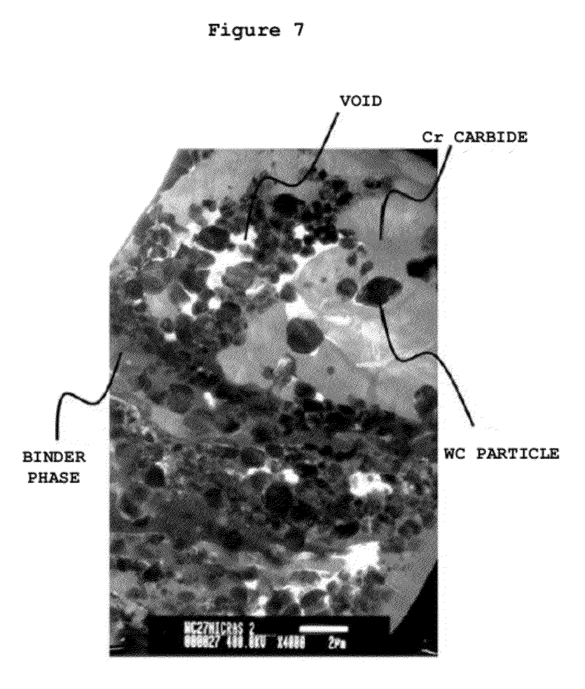

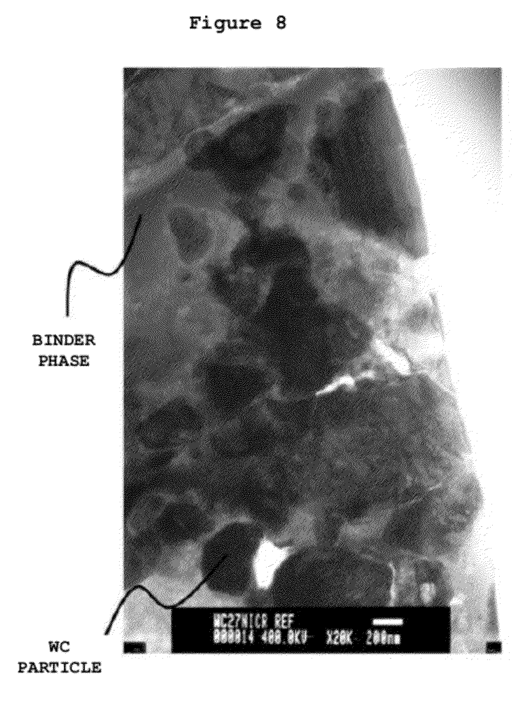

FIG. 7 shows a TEM photograph (low magnification) of the thermally sprayed cemented carbide layer, and FIG. 8 shows a TEM photograph (high magnification) thereof. It is found that the thermally sprayed cemented carbide layer has many very small defects which are difficult to be identified through SEM observation. Further, it can be confirmed that a nickel binder phase does not have an exceptionally fine metal texture.

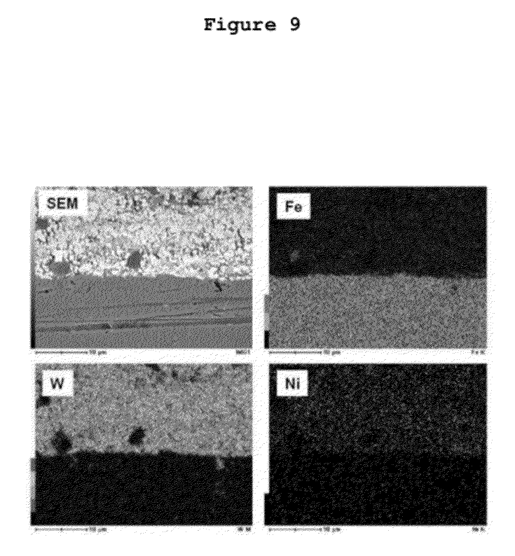

FIG. 9 shows an SEM photograph and EDS element mapping results of an interface between the thermally sprayed cemented carbide layer and the SKD61 sheet material. The distribution of each of W and Ni corresponds to a position of the thermally sprayed cemented carbide layer and the distribution of Fe corresponds to a position of the SKD61 sheet material. The diffusion of W and Ni into the SKD61 sheet material and the diffusion of Fe into the thermally sprayed cemented carbide layer are hardly observed.

### Example 2 (Friction Stir Process Applied to Thermally Sprayed Cemented Carbide Layer)

A high velocity flame spraying method was used to form a thermally sprayed cemented carbide layer (20 mass % of WC, 7 mass % of CrC, Ni) on an SKD61 sheet material. After that, a friction stir process was applied to the thermally sprayed cemented carbide layer. A tool made of a cemented carbide (WC-Co) and having a cylindrical shape with a diameter of 12 mm was used in the friction stir process, and the tool rotating at a speed of 600 rpm was pressed into the thermally sprayed cemented carbide layer at a load of 3,400 kg. The moving speed of the tool was set to 50 mm/min, and the oxidation of each of the tool and the sample was prevented by causing an argon gas to flow.

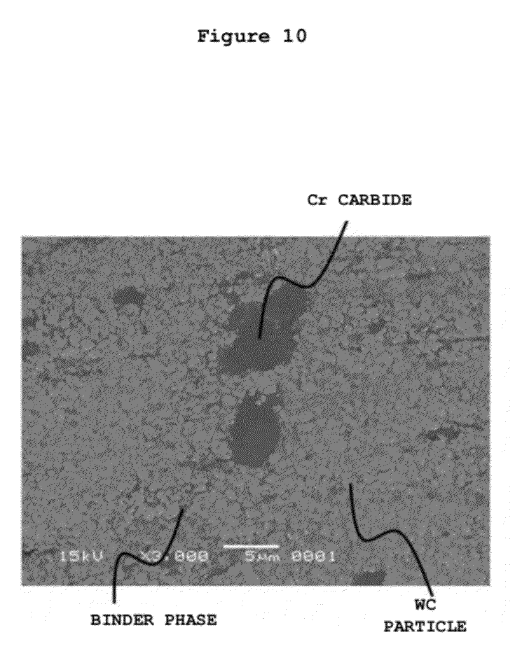

FIG. 10 shows an SEM photograph of the thermally sprayed cemented carbide layer modified by applying the friction stir process. The thermally sprayed cemented carbide layer before the friction stir process was applied had many defects such as voids, but such defects can be hardly observed in the thermally sprayed cemented carbide layer after the friction stir process.

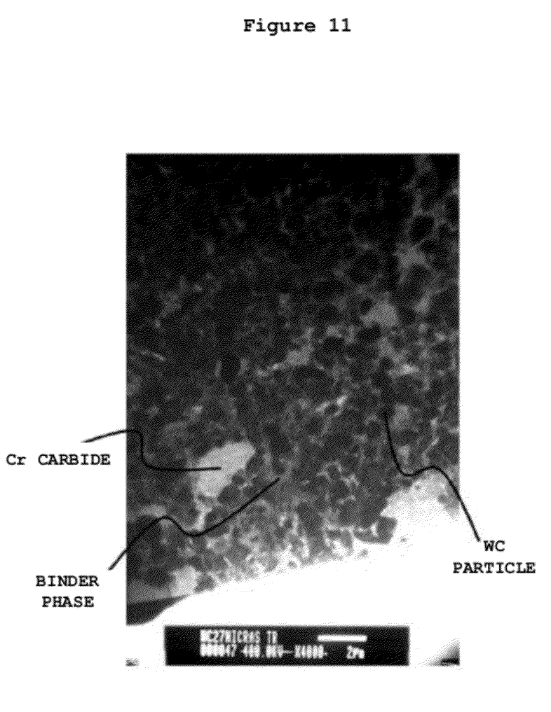

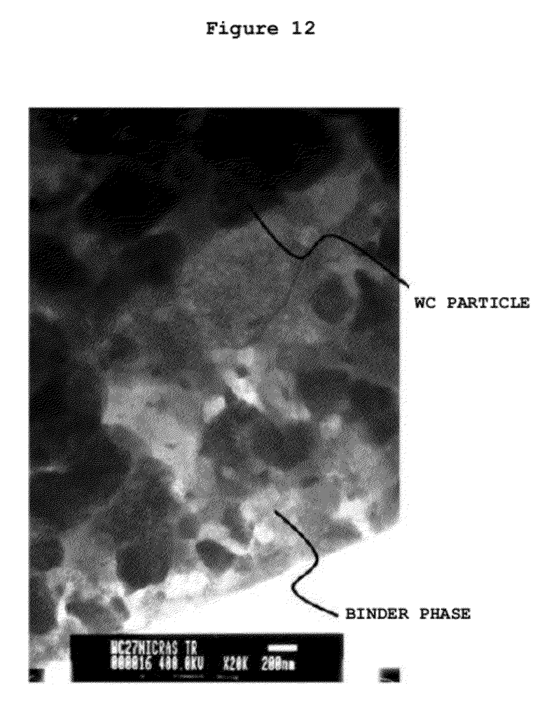

FIG. 11 shows a TEM photograph (low magnification) of the thermally sprayed cemented carbide layer modified by applying the friction stir process, and FIG. 12 shows a TEM photograph (high magnification) thereof. The thermally sprayed cemented carbide layer before the friction stir process had many very small defects which were difficult to be identified through SEM observation, but it is found that the application of the friction stir process has eliminated the defects and the densification of the thermally sprayed cemented carbide layer has progressed. In addition, it can be confirmed that the crystal grains in the nickel binder phase have been allowed to become finer so as to each have a size of nanometer order (1 μm or less).

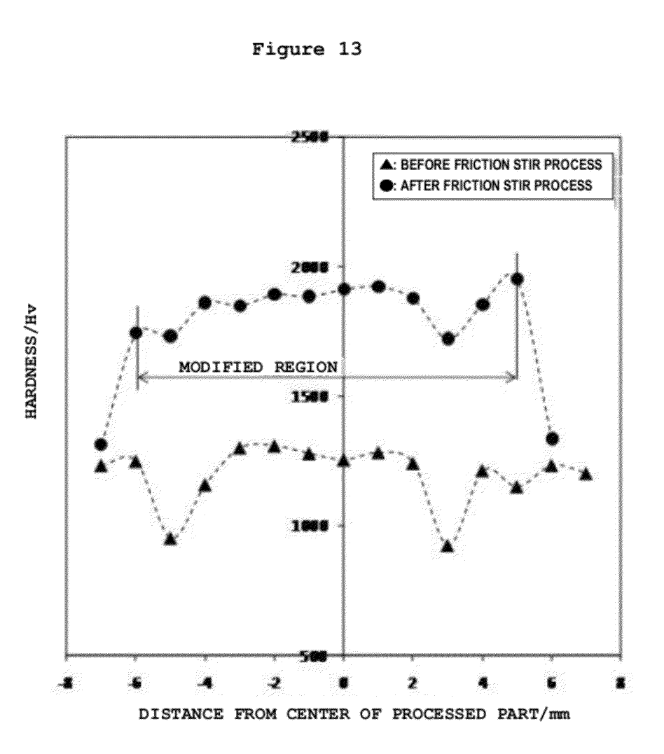

FIG. 13 shows a graph plotting the Vickers hardness (vertical direction profile at a position of a depth of 150 μm from the surface of the thermally sprayed cemented carbide layer) of the thermally sprayed cemented carbide layer measured before and after the friction stir process. The Vickers hardness was measured under the conditions of a load of 2.94 N (300 gf) and a retention time of 15 seconds. The hardness of the thermally sprayed cemented carbide coating measured before the friction stir process is about 1,250 HV and regions having defects each have a hardness of less than 1,000 HV. On the other hand, the hardness is significantly improved after the friction stir process, and regions each having a hardness of around 1,900 HV are extensively confirmed.

Table 1 shows the Vickers hardness of the SKD61 sheet material after the friction stir process measured along the depth direction from the welded interface with the thermally sprayed cemented carbide layer. The Vickers hardness was measured under the conditions of a load of 2.94 N (300 gf) and a retention time of 15 seconds. The hardness of an untreated SKD61 sheet material is about 400 to 450 HV, but the SKD61 sheet material after the friction stir process shows as high a hardness as 800 HV or more at a position immediately below the thermally sprayed cemented carbide layer. The gradual change in hardness from the thermally sprayed cemented carbide layer to the inside of the substrate is extremely ideal in regard to use for sliding members and the like.

TABLE 1

| | Distance from welded interface (nm) | | | | | | | | | | | | | |
|---|---|---|---|---|---|---|---|---|---|---|---|---|---|---|
| | 0.05 | 0.1 | 0.15 | 0.2 | 0.25 | 0.3 | 0.35 | 0.4 | 0.45 | 0.5 | 0.55 | 0.6 | 0.65 | 0.7 |
| Hardness | 837 | 739 | 728 | 672 | 660 | 652 | 612 | 560 | 550 | 528 | 461 | 461 | 429 | 429 |
| (HV) | | | | | | | | | | | | | | |

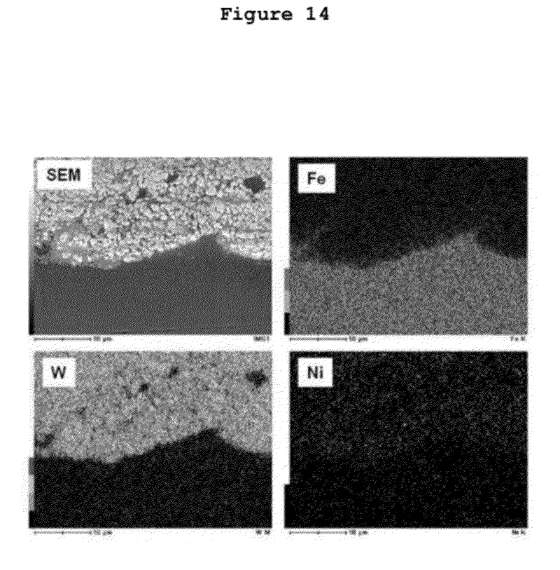

FIG. 14 shows an SEM photograph and EDS element mapping results of an interface between the thermally sprayed cemented carbide layer and the SKD61 sheet material after the friction stir process. In the vicinity of the interface between the thermally sprayed cemented carbide layer and the SKD61 sheet material, the outer edge of a region in which each element is distributed has an unclear shape. Further, the distribution of Fe spreads into the inside of the thermally sprayed cemented carbide layer, and the diffusion of Fe in the thermally sprayed cemented carbide layer is found. The results indicate that the thermally sprayed cemented carbide layer and the SKD61 sheet material are metallurgically welded.

### REFERENCE SIGNS LIST

10 . . . cemented carbide

12 . . . metal substrate

14 . . . thermally sprayed cemented carbide layer

20 . . . modified region

30 . . . tool for friction stir process

1-8. (canceled)

9. A method for modifying a cemented carbide, the method comprising a step of applying a friction stir process to a cemented carbide, thereby allowing crystal grains in a binder phase included in the cemented carbide to become finer.

10. The method for modifying the cemented carbide as recited in claim 9, wherein the cemented carbide comprises a cemented carbide layer, which is formed on a surface of a metal substrate by using a thermal spraying method.

11. The method for modifying the cemented carbide as recited in claim 10, wherein the metal substrate and the cemented carbide layer are welded metallurgically.

12. The method for modifying the cemented carbide as recited in claim 10, wherein the metal substrate has a higher hardness in a vicinity of an interface between the cemented carbide layer and the metal substrate in comparison to that before the applying of the friction stir process.

13. The method for modifying the cemented carbide as recited in claim 9, wherein the binder phase comprises nickel.

14. The method for modifying the cemented carbide as recited in claim 9, further comprising a step of using a tool made of cemented carbide, wherein the tool has a higher hardness than that of the cemented carbide to which the friction stir process is applied.

15. A cemented carbide modified by the method for modifying the cemented carbide as recited in claim 14.

16. The cemented carbide as recited in claim 15 further comprises a binder phase including crystal grains each having an average diameter of 1 μm or less.
